(19) United States
(12) Patent Application Publication
(10) Pub. No.: US 2002/0041041 A1
(43) Pub. Date: Apr. 11, 2002

(54) Hollow monolithic ceramic gas diffuser and method of manufacture

(76) Inventor: Kerry K. Johnson, Hornell, NY (US)

Correspondence Address: Howard J. Greenwald, Howard J. Greenwald, P.C., Suite 2490, West Commercial Street, East Rochester, NY, 14445, US

(21) Appl. No.: 09/725,526

(22) Filed: Nov. 29, 2000

Related U.S. Application Data
(63) Continuation-in-part of application No. 09/679,690, filed on Oct. 5, 2000, now abandoned.

(51) Int. Cl. B01F 3/04

(52) U.S. Cl. 261/122.1

(57) ABSTRACT

A ceramic diffuser assembly containing a diffuser fitting integrally connected to a diffuser body, Wwhen the ceramic diffuser assembly is supplied with oxygen-containing gas at a pressure of from about 0.2 to about 80 pounds per square inch, the gas flows through it at a rate of from about 0.5 to about 50 standard cubic feet per minute, the plot of gas pressure versus flow rate is a straight line, and the slope of said straight line is from about 0.1 to about 4. The diffuser body contains a first ceramic layer, a second ceramic layer, and a recessed area disposed between the first and second layers.

### CROSS-REFERENCE TO RELATED PATENT APPLICATION

This application is a continuation-in-part of applicant's copending patent application U.S. Ser. No. 09/679,690, filed on Oct. 5, 2000.

### FIELD OF THE INVENTION

A ceramic diffuser body with a hollow core.

### BACKGROUND OF THE INVENTION

In 1996 U.S. Pat. No. 5,560,874 issued to Chad A. Sheckler and Harry C. Stanton. This patent described and claimed a ceramic diffuser body which was useful, e.g., in diffusing corrosive gases such as oxygen and ozone. The ceramic nature of the Sheckler diffuser body provided resistance against corrosion.

### SUMMARY OF THE INVENTION

In accordance with this invention, there is provided a ceramic diffuser body comprised of a top ceramic layer integrally connected to a bottom ceramic layer with a recess disposed between said top ceramic layer and said bottom ceramic layer. When a pressure of from about 0.2 to about 40 pounds per square inch is applied to the diffuser body, a gas flow is produced which is directly proportional to such pressure; and a plot of the gas flow versus gas pressure will yield a straight line with a slope of from about 0.1 to about 4. The bottom ceramic layer has a minimum active pore size of from 0.2 to about 90 microns, the top ceramic layer has a minimum active pore size of from about 0.2 to about 90 microns, but the minimum active pore size of the top ceramic layer is at least 1.1 times as great as the average pore size of the bottom ceramic layer. Each of the top and bottom ceramic layers has an apparent porosity of from about 10 to about 90 percent. The top ceramic layer has a permeability which is at least ten percent greater than the permeability of the bottom layer, and each such layer preferably has a permeability of from about 0.001 to about 10 Darcys. The recess can have a thickness ranging over a wide area of from 10 to about 80 percent of the thickness the diffuser body, which latter thickness preferably ranges from about 6 millimeters to about 90 millimeters. The thickness of both the bottom ceramic layer and the top ceramic layer is from about 8 to about 80 percent of total thickness of the diffuser body.

### BRIEF DESCRIPTION OF THE DRAWINGS

The invention will be described by reference to the specification and the following drawings, in which like numerals refer to like elements, and in which:

FIG. 1 is a sectional view of one preferred diffusion assembly of this invention;

FIG. 2 is an exploded sectional view of one preferred diffusion assembly of the invention;

FIG. 3 is a sectional view of the diffusion assembly of FIG. 2;

FIG. 3A is partial perspective view of the diffusion assembly of FIG. 2, with a portion of the assembly shown broken away to reveal some of the details of the interior structure.

FIG. 4 is a partial sectional view of one preferred diffuser body of the invention, showing a particular arrangement of flow modifiers within the diffuser body;

FIG. 5 is a partial sectional view of another preferred diffuser body of the invention, showing another arrangement of flow modifiers within the diffuser body;

FIG. 6 is a sectional view of another preferred diffuser body of the invention;

FIG. 7 is a schematic representation of one preferred process for producing the diffuser body of the invention;

FIG. 8 is a flow diagram further illustrating the process of FIG. 6; and

FIG. 9 is a graph of flow rate versus pressure for one preferred diffuser assembly of this invention.

### DESCRIPTION OF THE PREFERRED EMBODIMENT

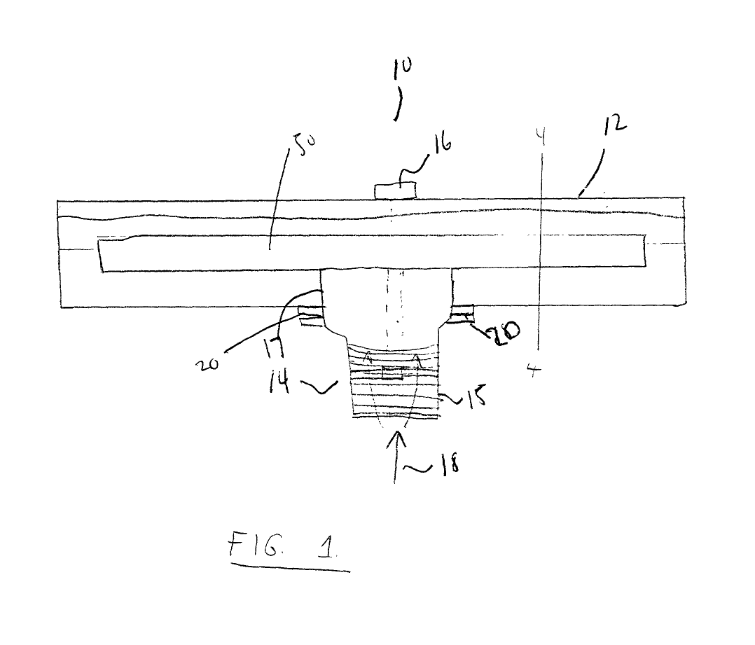

FIG. 1 is a sectional view of a ceramic diffuser assembly 10 comprised of a ceramic diffuser body 12 connected to fitting 14 by means of connector 16. Typically an oxygen-containing gas (not shown), such as air, oxygen, and/or ozone, is introduced in the direction of arrow 18 into fitting 14 and through the ceramic diffuser body 12 up into a body of liquid to be treated.

As is known to those skilled in the art, ceramic diffuser assemblies are frequently used to purify bodies of water by contacting impurities in such water with fine bubbles of oxygen-containing gas. A multiplicity of ceramic diffuser assemblies are commonly connected in series to a source of the oxygen-containing gas (such as a compressor and/or a gas generator); and each of the ceramic diffuser assemblies treats a specified area of the water.

In the embodiment depicted in FIG. 1, the ceramic diffuser assembly is held together by connector 16 as well as a gasket 20. Because the gasket 20 frequently is made from elastomeric material which may be attacked by the oxygen-containing gas, it often is preferred to use an oxygen or ozone-resistant gasket. In another embodiment, not shown, both the gasket 20 and the connector 16 are dispensed with and the fitting 14 is bonded to the ceramic diffuser body 12. This can be done by cutting a suitable orifice within the ceramic diffuser body and, by the use of either heat and/or adhesive means (such as epoxy), bonding the fitting 14 to the ceramic diffuser body 12.

Fitting 14 may be any fitting conventionally used with diffusers. Thus, by way of illustration and not limitation, one may use one or more of the fittings described in U.S. Pat. Nos. 4,960,546 (a tubular plastic diffuser Tee fitting providing a flow passage therethrough), reissue patent 33,177,6,106,704,6.105,885 (lock nut or wedge fitting), 6,096,203,6,089,027 (fitting 336), 6,085,540 (fitting 39), 6.065,203 (nut or wedge fitting), 6,062,704 (diffuser element fitting), 5,863,031,5,846,412 (Tee fitting), 5,788,847 (Tee fitting), 5,725,245 (threaded fitting), and the like. The disclosure of each of these United States patents is hereby incorporated by reference into this specification.

One preferred diffuser fitting 14 is described in U.S. Pat. No. 5,863,031 of Richard K. Veeder et al., the entire disclosure of which is hereby incorporated by reference into this specification. Thus, as is disclosed at column 3 of such patent, one may use a orifice fitting 30 formed of an inert material (such as, e.g., an organic polymer of a ceramic material).

In one embodiment, fitting 14 is comprised of a fluorinated polymer which, preferably, comprises polytetraflluoroethylene (PFTE). Commercial polytetrafluoroethylene is sold under the trademark of TEFLON which is sold by the E. I.. duPont deNemours and Company of Wilmington, Del.

In general, the fitting 14 may be made from any fluorocarbon polymer. These materials are chemically inert, nonflammable, and stable to heat up to about a temperature of 260 degrees Centigrade. Suitable fluorocarbon polymers include, by way of illustration and not limitation, polytetrafluorethylene, polymers of chlorotrifluoroethylene, fluorinated ethylene-propylene polymers, polyvinylidene fluoride, hexafluoropropylene, and the like.

The fitting may be made to order, to any particular size, from either the fluorocarbon powder (by melting and injection molding) and/or from the fluorocarbon block material (by machining). In general, and as depicted in FIG. 1, the fitting 14 will be comprised of a first stepped section 15 integrally connected to a second, wider stepped section 17.

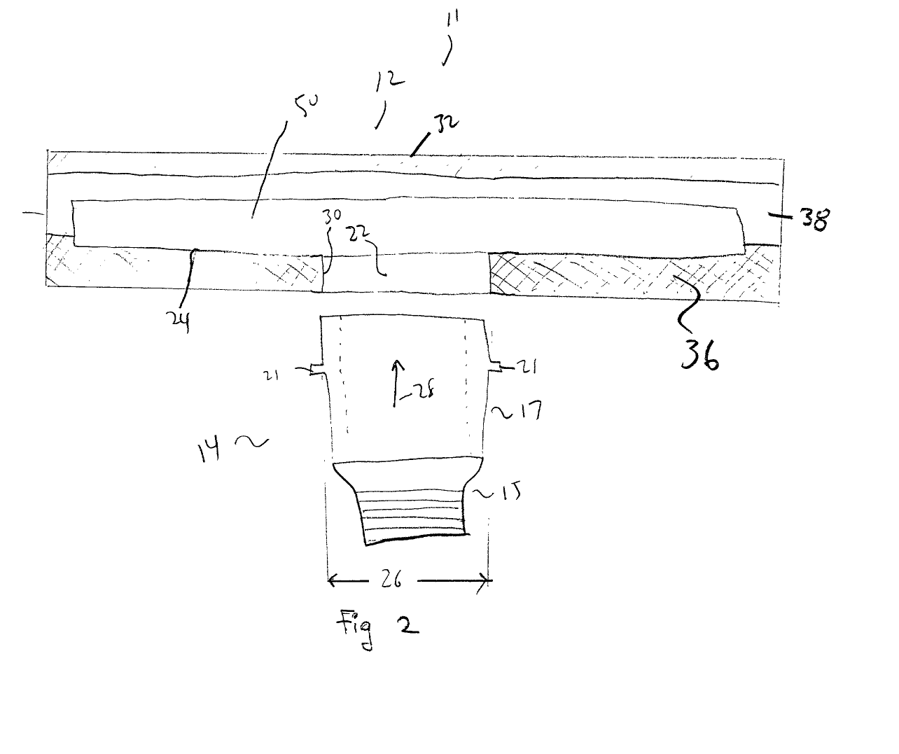

FIG. 2 is a schematic representation of one preferred process for making the diffusion assembly 10 of FIG. 1. In the first step of this process, an orifice 22 is cut into the bottom wall 24 of diffuser assembly 12 so that it has substantially the same diameter as diameter 26 of stepped section 17. Thereafter, the ceramic bottom wall 24 of diffuser 24 is heated to a high temperature (often on the order of from about 100 to 350 degrees Centigrade) and, thereafter, the fitting 14 is forced in the direction of arrow 28 into orifice 22 wherein it will be friction fit and wherein the heat from bottom wall 24 will melt a portion of the surface of fitting 14 and mechanically bond thereto.

In another embodiment, not shown, one may apply adhesive to the inner wall 30 which defines orifice 22 and thereafter force fitting 14 in the direction of arrow 28 into orifice 22 in order to create an adhesive bond.

One may use any suitable epoxy adhesive. Thus, by way of illustration and not limitation, one such adhesive may be made by mixing alumina powder with a particle size of from 0.5 microns to about 60 microns and from about 10 to about 30 parts (by weight of solid alumina) of ethanol until all of the alumina particles are wetted. This paste/slurry may then be mixed with about from 15 to about 35 parts (by weight of total weight of solid alumina) of polytetrafluoroethylene powder with a particle size of from about 1 to about 50 microns until the polymer particles adhere to the wetted alumina particles. This mixture is then applied to surface 30, the fitting 14 is then inserted into orifice 22, and the assembly is then heated to a temperature of from about 300 to about 550 degrees Fahrenheit (and preferably from about 510 to about 530 degrees Fahrenheit) for at least about one hour (and preferably from about 1 to about 3 hours) to securely bond the fitting 14 to the diffuser body 12.

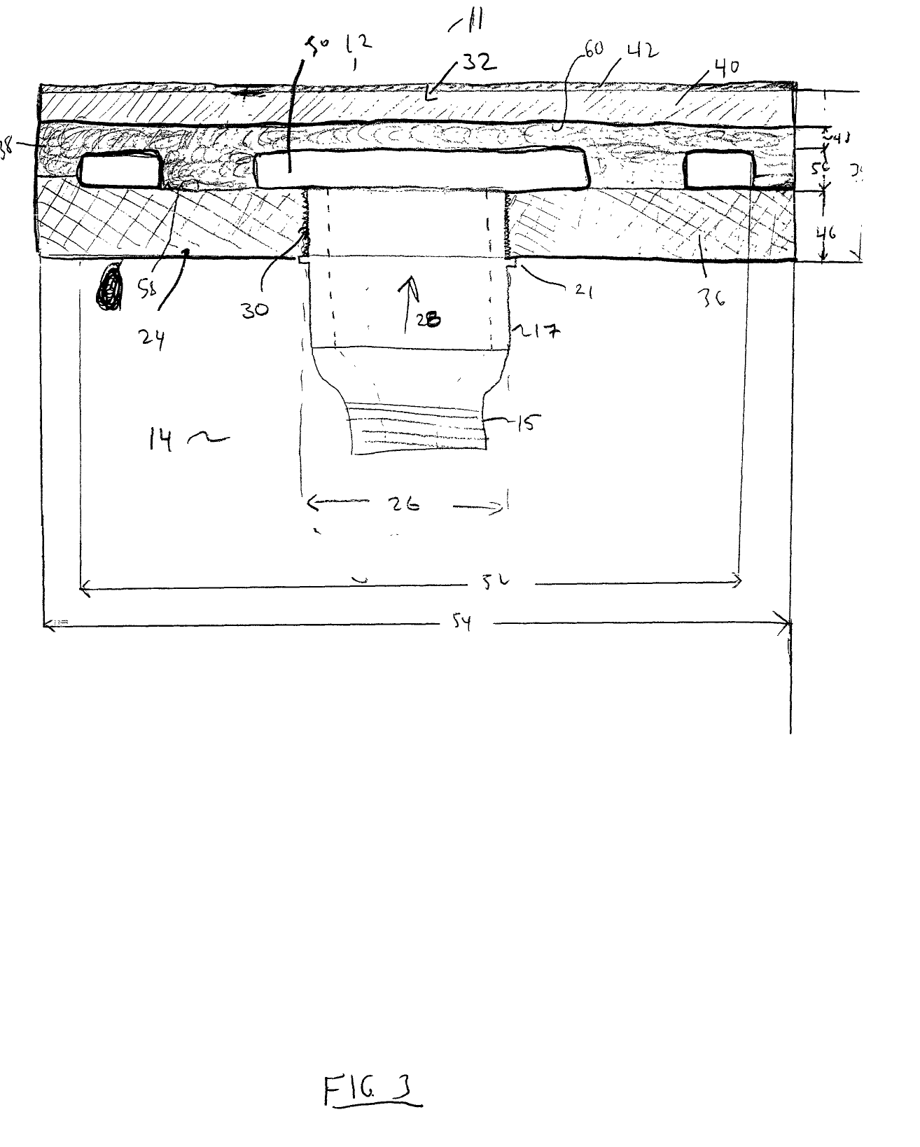

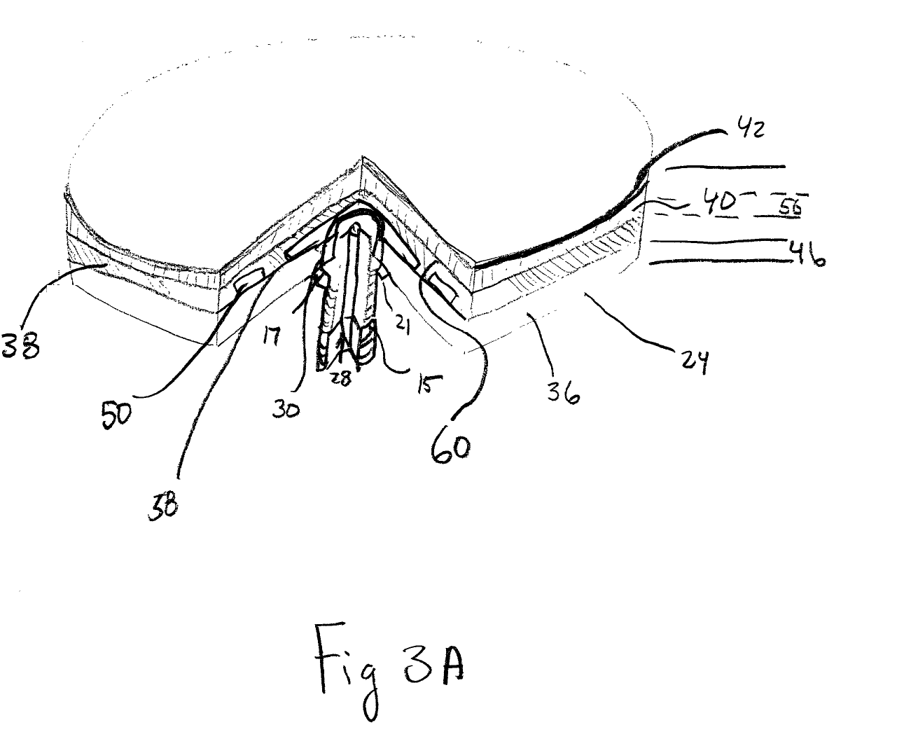

As will be apparent to those skilled in the art, the assembly of FIG. 2 (and of FIG. 3) does not require the use of a gasket 20 (see FIG. 1), thereby rendering it more durable in use. Furthermore, the assembly of FIG. 2 does not require the use of a fastener 16, thereby providing more open surface area on the top surface 32 to effect diffusion of the oxygen-containing gas. Furthermore, the problem of corrosion of fastener 16 (see FIG. 1) is avoided by the use of assembly 11 of FIG. 2.

Referring to FIG. 3, and the diffusion apparatus 11 depicted therein, it be seen that the diffusion body 12 portion of such device preferably has a thickness 34 of from about 6 to about 90 millimeters and, preferably, from about 10 to about 80 millimeters. In one embodiment, thickness 34 is from about 20 to about 50 millimeters.

The ceramic diffuser 12 is comprised of a first ceramic layer 36 integrally connected to second ceramic layer 38. In the preferred embodiment depicted in FIG. 3, a third ceramic layer 40 is integrally connected to ceramic layer 38; and a fourth ceramic layer 42 is integrally connected to and bonded to ceramic layer 40.

In general, it is preferred to use at least three layers (such as layers 36, 38, and 40) in diffuser 12. In one embodiment, it is preferred to use at least four such layers (such as layers 36, 38, 40, and 42).

Each of the layers 36, 38, 40, 42, et seq. (if any) preferably is comprised of a ceramic material. It is preferred that the ceramic material(s) used in such layers have a surface tension of from about 100 to about 2000 milliNewtons per meter. Means for measuring the surface tension of a ceramic material are well known to those skilled in the art and are described, e.g., in U.S. Pat. Nos. 4,751,532, 6,093,504, 5,982,597, 5,962,388, 5,943,366, 5,906,871, 5,865,935, 5,737,178, and the like. The disclosure of each of these United States patents is hereby incorporated by reference into this specification.

Some of the preferred ceramic materials which can be used in layers 36 and/or 38 and/or 40 and/or 42 et seq. include, e..g, alumina, zirconia, silicon carbide, titanium carbide, and the like.

In one embodiment, some or all of the ceramic material(s) in layers 36 and/or 38 and/or 40 and/or 42 et seq. are replaced with one or more metal materials (such as magnesium, stainless steels, brass), and/or polymeric materials (such as polyvinyl chloride, fluorinated polymers), carbon powders, and graphite. As is known to those skilled in the art, these materials, especially when in powder form, can be formulated to make porous bodies. Thus, e.g., magnesium powder can be compacted into a body and partially sintered to form a rigid, porous body. Thus, e.g., polymeric powder materials can be compacted and partially melted. Thus, e.g., compacts of carbonaceous materials can be mixed with binders (such as carbon pitches and/or petroleum cokes) and partially melted.

Referring again to FIG. 3, and in the preferred embodiment depicted therein, it is preferred that the surface tension of top layer 42 (or in the case of a two-layer device, of the layer which is actually exposed to the water on its top surface) have a surface tension which is at least about ten percent greater than the surface tension of adjacent layer 40. Without wishing to be bound to any particular theory, applicant believes that, when such a condition exists, the flow characteristics of assembly 11 are optimized.

Thus, by way of illustration, and referring to FIG. 3, top layer 42 may consist essentially of silicon carbide, and adjacent layer 40 may consist essentially of alumina. By way of further illustration, top layer 42 may consist essentially of silica, and adjacent layer 40 may consist essentially of alumina.

Referring again to FIG. 3, and in the preferred embodiment depicted therein, it will be seen that each of layer 36 and 38 have thickness 46 and 48, respectively, which is from about 8 to about 80 percent of the total height 34 of diffusion body 12. It is preferred, but not essential, that thickness 46 be at least 1.1 times as great as thickness 48.

It will be seen that, in the preferred embodiment depicted in FIG. 3, the diffuser body 12 is comprised of a hollow interior 50 which will have a length 52 which is from about 50 to about 90 percent of the length 54 of ceramic diffuser body 12. In general, ceramic diffuser body 12 will have a length (or diameter when it has a circular cross-sectional shape) of from about 50 millimeters to about 762 millimeters). The width 56 of recess 50 is from about 10 to about 80 percent of the total thickness 34 of diffuser body 12 and, preferably, will be from about 10 to about 40 percent of the total thickness 34 of diffuser 12, provided that the width 56 of such recess 50 is at least about 3 millimeters. In one embodiment, width 46 is from about 10 to about 30 percent of thickness 34. Applicant has discovered that when the recess has a size outside of these dimensions, the diffuser assembly 11 does not function as well.

In the embodiment depicted in FIG. 2, the recess 50 is substantially hollow and is formed by the integral connection of layers 36 and 38. In the embodiment depicted in FIGS. 3, 4, and 5, the recess is partially filled with flow modifying structures, but it is still a recess for the purposes of this specification, be a shape formed by the integral connection of layers 36 and 38.

In another embodiment, not shown, the recess 50 is filled with coarse ceramic grit between about 36 grit up to about 6 grit. This recess, even though it is completely filled, is deemed to be a recess for the purposes of this invention.

In fact, an space formed by the integral connection of layers 36 and 38, whether completely empty, partially filled, or completely filled, is deemed to be a recess 50 within the scope of this invention.

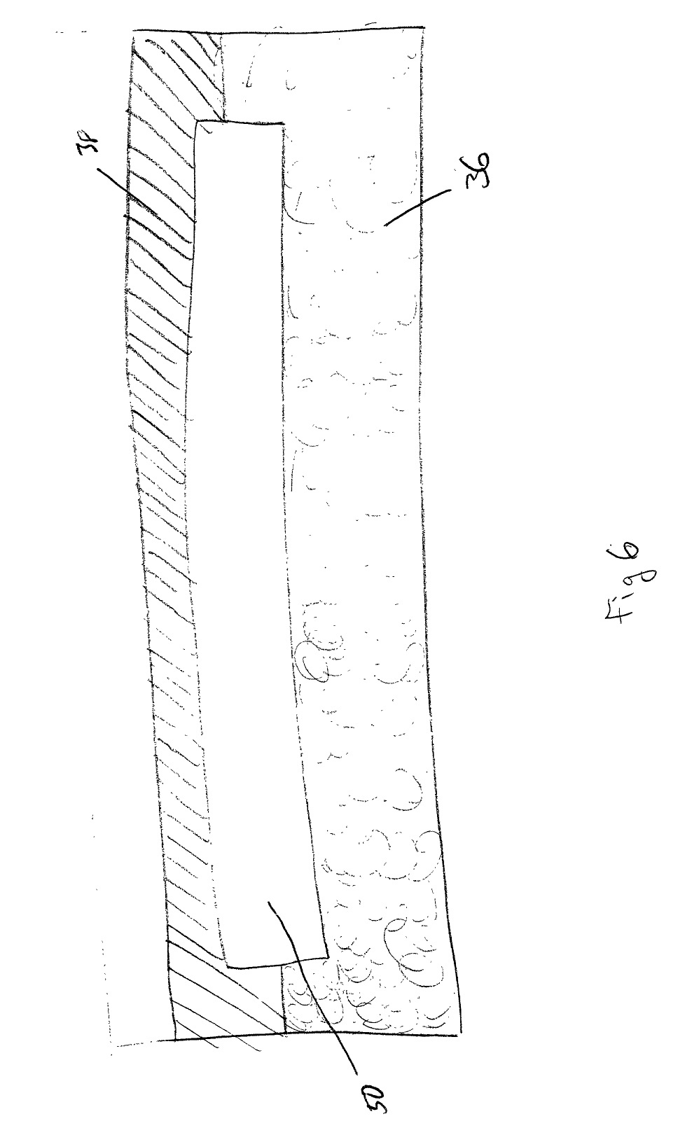

In the embodiment depicted in FIG. 3, the top layer of assembly 11 is layer 42. In the embodiment depicted in FIG. 6, the top layer of the assembly is layer 38. Regardless of what the top layer is for any particular assembly, it will have a higher permeability that the layer to which it is most immediately adjacent to and bonded to. Thus, e.g., referring to FIG. 3, top layer 42 has a higher permeability than does adjacent layer 40. Thus, e.g., referring to FIG. 6, top layer 38 has a higher permeability than adjacent layer 36.

In general, the top layer of the assembly will have permeability that is at least about ten percent greater than its next adjacent layer; and the permeability for all of the layers in the assembly will generally range from about 1 milliDarcy to about 10 Darcys. Means for measuring the permeability of ceramic materials are well known to those skilled in the art and are described, e.g., in U.S. Pat. Nos. 5,881,825, 5,560,438, and the like. The entire disclosure of each of these United States patents is hereby incorporated by reference into this specification.

Referring again to FIG. 3, and in the preferred embodiment depicted therein, the permeability of bottom layer 36 is also within the range of from about 1 milliDarcy to about 10 Darcy's, provided that the permeability of bottom layer 36 is less than the combined permeabilities of the top layer and its next adjacent layer. When the term “combined permeability” of two layers is referred to herein, it means the permeability measurement obtained when the permeability of the bonded layer structure is measured.

One preferred means of determining permeability is by use of the “Capillary Flow Poromoter” sold by Porous Materials Inc. of Cornell University Research and Technology Park, 83 Brown Road, Building 4, Ithaca, N.Y. Several articles describing the technique for measuring porosity are also presented in the web site for Porous Materials Inc.

Referring again to FIG. 3, the top layer of assembly 11 is layer 42. In the embodiment depicted in FIG. 6, the top layer of the assembly is layer 38. Regardless of what the top layer is for any particular assembly, it will have a higher minimum active pore size that the layer to which it is most immediately adjacent to and bonded to. Thus, e.g., referring to FIG. 3, top layer 42 has a higher minimum active pore size than does adjacent layer 40. Thus, e.g., referring to FIG. 6, top layer 38 has a higher minimum active pore size than adjacent layer 36.

The term minimum active pore size is well known to those skilled in the art and is described, e.g., at Column 7 of U.S. Pat. No. 5,560,874; the entire disclosure of such United States patent is hereby incorporated by reference into this specification.

The pore size distribution of a porous body may be determined in accordance with A.S.T.M. Standard Test Method F316-86, “Test Method for Pore Size Characterization . . . .” In this test, porous bodies are mounted on a glass plenum and immersed in a liquid of known surface tension. The plenum is slowly pressurized, and observations are made of the pressure at which the first bubble is released from the body at various gas flow rates.

In general, the top layer of the assembly will have a minimum pore size that is at least about ten percent greater than the minimum pore size of its next adjacent layer; provided that the minimum pore size of such top layer and its adjacent layer are both within the range of from about 0.2 to 90 microns.

Referring to FIG. 3, and also to FIG. 6, the bottom layer 36 diffuser body 12 also has a minimum pore size of from about 0.2 to 90 microns, provided that the minimum pore size of such bottom layer 36 is less than the minimum pore size of the intermediate layer adjacent to and bonded to the top layer.

Referring again to FIG. 3, the top layer of assembly 11 is layer 42. In the embodiment depicted in FIG. 6, the top layer of the assembly is layer 38. Regardless of what the top layer is for any particular assembly, it preferably (but not necessarily) will have a higher apparent porosity that the layer to which it is most immediately adjacent to and bonded to. Thus, e.g., referring to FIG. 3, top layer 42 preferably has a higher minimum higher apparent porosity than does adjacent layer 40. Thus, e.g., referring to FIG. 6, top layer 38 preferably has a higher apparent porosity pore size than adjacent layer 36.

The term apparent porosity is well known to those skilled in the art and is described, e.g., of U.S. Pat. No. 5,560,874; the entire disclosure of such United States patent is hereby incorporated by reference into this specification.

The apparent porosity of a porous body is the relationship of the open pore space to the bulk volume, expressed in percent (see, e.g., A.S.T.M. C242-87).

In general, the top layer of the assembly will have an apparent porosity that is at least about ten percent greater than the apparent porosity its next adjacent layer; provided that the apparent porosity of such top layer and its adjacent layer are both within the range of from about 10 to 90 percent.

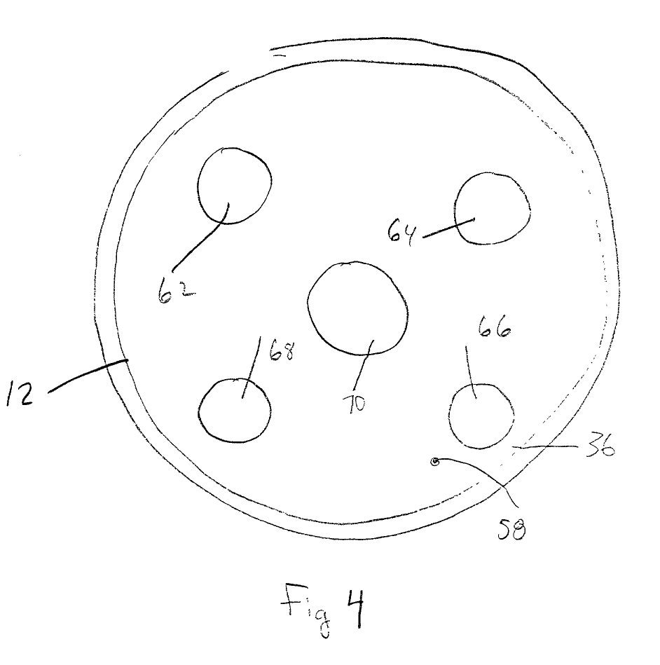

Referring to FIG. 3, and in the preferred embodiment depicted therein, in one optional embodiment the recess is not entirely empty but is partially filled with flow modifying structures extending between the top surface 58 of layer 36 and the bottom surface 60 of layer 38. As will be apparent to those skilled in the art, these flow modifying structures tend to create turbulence in the gas traveling within recess 50. One typical arrangement of these flow modifying structures is illustrated in FIG. 4.

Referring to FIG. 4, a top cross-sectional view is shown of a diffuser body 12 in which flow modifying structures 62, 64, 66, and 68, which extend from the top surface 58 of layer 36 to the bottom surface 60 (not shown) of layer 38 (not shown). Orifice 70 communicates with fitting 14 (not shown).

It will be seen that top surface 58 has a cross-sectional area, the majority of which is not occupied by any of the flow modifying structures 62, 64, 66, and 68. In one embodiment, from about 7 to about 20 percent of such cross-sectional area is occupied by the flow modifyijng structures 62, 64, 66, and 68. In one embodiment, from about 7 to about 10 percent of such cross-sectional area is occupied by such flow modifying structures.

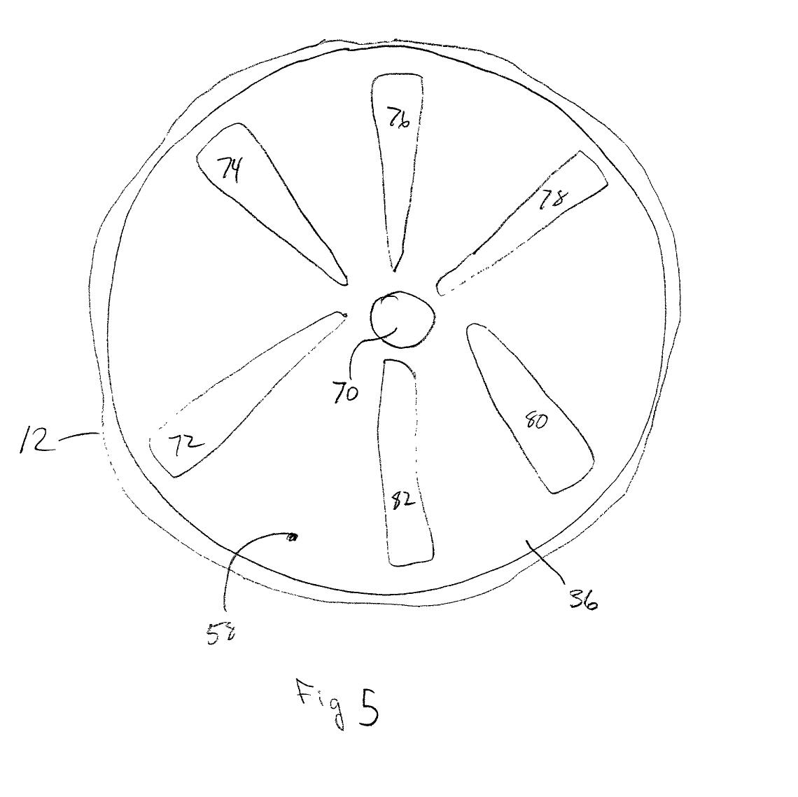

FIG. 5 is a cross-sectional view of another preferred diffuse body 12 which contains different flow modifying devices 72, 74, 76, 78, 80, and 82, all of which also preferably extend from the top surface 58 of layer 36 to the bottom surface 60 (not shown) of layer 38 (not shown). It will be appreciated that FIGS. 4 and 5 are not necessarily drawn to scale. The flow modifying devices 72,m 74, 76, 78, 80, and 82, in combination, also comprise only from about 7 to about 20 percent (and preferably from about 7 to about 10 percent) of the cross-sectional area of top surface 58.

FIGS. 4 and 5 have illustrated to possible shapes which may be used as the flow modifying agents. Many other shapes may be used and are within the scope of the invention.

FIG. 6 is a sectional view of a diffuser body 12 with no orifice 22 (see FIG. 22), no flow modifiers (see FIGS. 4 and 5), and no layer 40 and no layer 42.

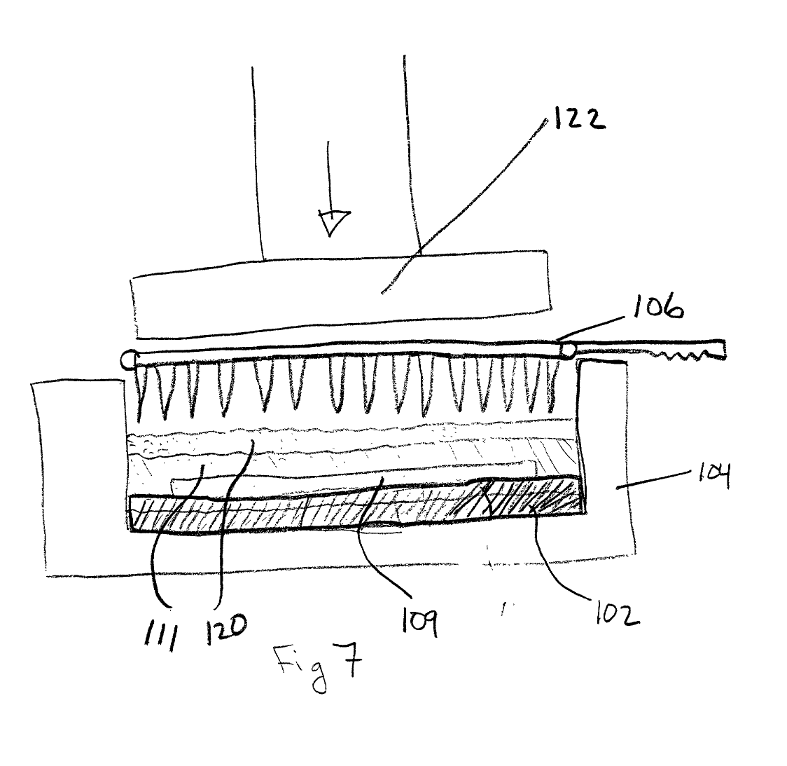

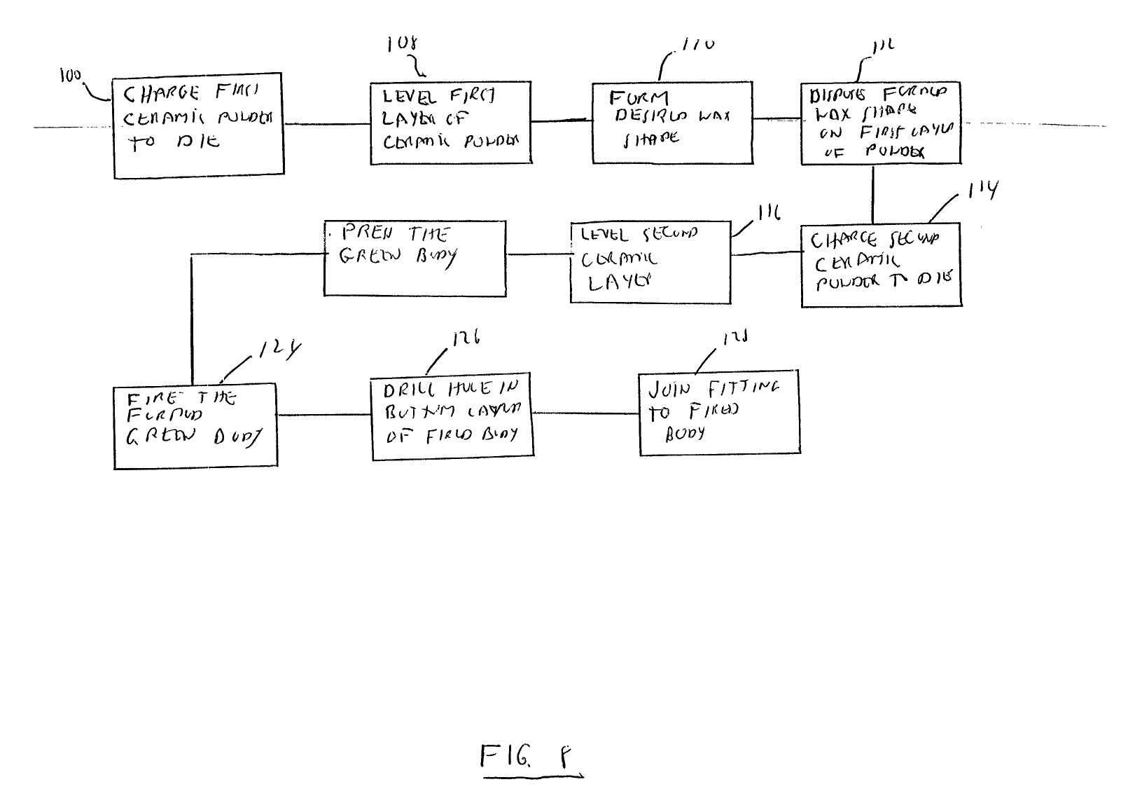

FIGS. 7 and 8 illustrate an example of a preferred process for preparing the assemblies of this invention. Referring to FIG. 8, in step 100 thereof, a first layer of ceramic powder 102 is charged into a die 104. The ceramic powder, when sintered, will preferably have the and dimensions described for layer 36 (see FIGS. 1, 2, and 3 and the corresponding description thereof). In one preferred embodiment, ceramic powder 102 is 240 grit alumina powder which is poured into die 104 to a height of about 20 millimeters and leveled with rake 106 in step 108.

In step 110 (see FIG. 8, and also FIG. 7) a preferred wax shape 109 is formed and thereafter, in step 112, disposed on top of the first leveled layer 102.

The preferred wax shape 109 may be made from any wax which has a melting temperature greater than 100 degrees Fahrenheit and, preferably greater than 150 degrees Fahrenheit. The wax also preferably contains less than about 5 weight percent of ash, after being subjected to a temperature of at least about 2,200 degrees Fahrenheit for at least about 1 hours. The wax also will be substantially transformed into carbonaceous and other gaseous material after having been subjected to such temperature of at least about 2,200 degrees Fahrenheit for at least about 1 hours.

Furthermore, the wax should retain its dimensional stability at room temprature.

Examples of some suitable waxes which may be used in the process include paraffin, microcrystalline waxes, beeswax, citronella wax, and the like, preferably in the form of a thin shaping wax sheet with a thickness of from about 6 to about 90 millimeters (see, e.g., U.S. Pat. No. 4,403,326, the entire disclosure of which is hereby incorporated by reference into this specification.). Many of the waxes which may be used in the process are described on pages 900-901 of George S. Brady et al.'s “Materials Handbook,” Thirteenth Edition (McGraw-Hill, Inc, New York, N.Y. 1991).

The wax is preferably in the form of a sheet which is formed into the shape of the desired recess 50. If one or more flow modifying structures 62, 64, 66, and 68 are desired (see FIG. 4), appropriate holes or other crevices are cut through the wax.

In one embodiment, the wax is injection molded into the desired shape. In another embodiment, the wax is cast into the desired shape. In yet another embodiment, the wax is pressed into the desired shape.

In one embodiment, a steel rule die is used to form the desired wax shape from a wax sheet.

Regardless of how the desired wax shape is formed, once formed it is disposed on top of the leveled first layer 102. Thereafter, in step 114 (see FIG. 8), a second ceramic powder 111 (see FIG. 7) is charged to the die 104 with material and amount sufficient to form the layer 38 after sintering (see FIGS. 1, 2, and 3 and the corresponding description in this specification). The second ceramic powder will pass through any holes or crevices in the wax shape and, ultimately, be formed into one or more of the flow modifying devices 62 et seq.

After the second ceramic layer 111 has been charged, it is leveled in step 116 with the rake 106. By way of illustration, this second ceramic layer may consist essentially of 180 alumina powder.

Thereafter, in step 118, one may optionally charge one or more additional ceramic layers (such as, e.g., ceramic layer 120). Thus, e.g., ceramic layer 120 maybe 100 grit alumina powder.

It is preferred, when utilizing the process depicted in FIG. 7, that the alumina grit charged to form ceramic layers 102, 111, and 120 be admixed with from about 3 to about 25 weight percent of binder. One may use any binder adapted to form a shaped article with the particular ceramic material used upon pressing. Thus, e.g., one may use as a green binder an emulsion of paraffin water, a Carbowax solution in water, polyvinyl alcohol, dextrine, and the like. In one embodiment, a mixture of dextrine and Mobilicer J wax may be used. See, e.g., U.S. Pat. No. 5,560,874, the entire disclosure of which is hereby incorporated by reference into this specification.

By way of further illustration, one may use sodium silicate as a binder. Furthermore, one may use one or more of the green binders disclosed in U.S. Pat. Nos. 4,918,874, 4,233,079 (lignosulfonates or aluminum sulfate), 4,210,454 (high alumina cement), hydraulic cements, cellulose binders, starch, polyethylene glycol, beeswax in powdered form, paraffin wax in powdered forms, and the like.

Once the green body has been formed, as illustrated in FIG. 7, it pressed in step 124 with press 122 with a force of from about 2 tons to about 350 tons, preferably with from about 7 to about 14 tons. As will be apparent to those skilled in the art, the larger the green body, the more force is required to form a part that exhibits suitable green strength for handling. It will be apparent to those skilled in the art that, prior to the beginning of the pressing operation, the rake 106 is removed from the path of the press.

After the green body has been formed, it fired to cause the ceramic material to bond to one another and form a porous structure. Thus, one may cause sintering of the pressed green body by firing it at a temperature of from about 2,500 to 2,850 degrees Fahrenheit.

The firing reaction is controlled so that less than complete sintering occurs. As will apparent, if the fired body is completely sintered, it will lack the desired degree of porosity. Thus, using standard sintering criteria and conditions, the process is controlled to achieve both a fired body with the desired degree of structural integrity and the desired porosity, pore size, and permeability characteristics.

In one embodiment, a flux is added to the ceramic powder and the binder to lower the firing temperature necessary to obtain the desired degree of partial sintering. The of such a flux is well known and is described, e.g., in U.S. Pat. No. 5,560,874. During this firing step, the wax and binder materials are gasified and escape from the porous body, creating both the recess 50 and porosity.

After the fired body has been produced, and in step 126 an orifice is cut into it (see FIG. 2) by conventional means. One may use, e.g., a diamond core drill to cut such orifice.

Thereafter, in step 128, the fitting 14 (see FIG. 2) is joined to the fired body by the means described elsewhere in this speficaition.

In one embodiment, not shown, in addition to using a first wax piece to form recess 50, one may also utilize a second wax piece disposed in die 104 prior to the time the first ceramic layer 102 is charged, thereby ultimately forming the orifice 22 when the pressed green body is fired.

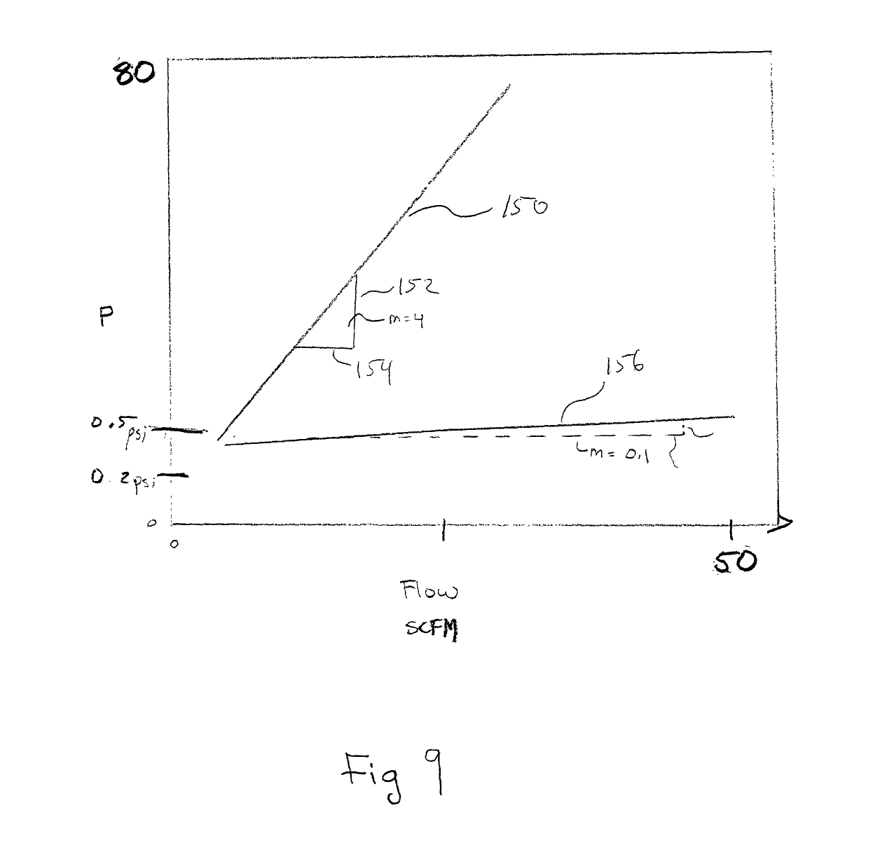

The aforementioned characteristics of the diffuser bodies 12 are controlled in the manner described in order to obtain a diffuser assembly 10 (see FIG. 1) which will have the desired flow characteristics within a specified pressure range. The numbers given in FIG. 9 and in this specification are illustrative.

Thus, referring to FIG. 9, and over a range of gas pressure of from about 0.5 to about 80 pounds per square inch, and a range of flow rates of from about 0.5 to about 50 standard cubic feet per minutes, the flow rates varies linearly with the gas pressure.

Plot 150 illustrates the response of one diffuser assembly whose slope (rise 152 over run 154) is about 4. Plot 156 illustrates the response of another diffuser assembly whose slipe is about 0.1. Regardless of the diffuser assembly used in this invention, over the specified ranges of gas pressure and flow rate, the slope of the plot will vary from 0.1 to about 4.0 and, and the plot will be linear.

In one preferred embodiment, and referring to FIG. 2, ceramic layer 36 has a higher dynamic wet pressure (DWP) than does ceramic layer 38, which, in turn, has a higher dynamic wet pressure than does layer 32. In general, the differences in dynamic wet pressures between such layer 36 and layer 38, and between such layer 38 and layer 32, is at least about ten percent.

As is known to those skilled in the art, one may determine the bubble point of a ceramic body by conventional means; see, e.g., U.S. Pat. Nos. 6,126,826,6,110,369,6,063,164, 6,058,773, and 6,045,899, the entire disclosures of each of which is hereby incorporated by reference into this specification. As is known to those skilled in the art, pore size can be estimated by porometry analysis and by separate measurement of the bubble point, with a higher bubble point indicating tighter pores. Porometry consists of applying gradually increasing pressures on a wet membrane and comparing gas flow rates with those of the dry membrane which yields data on pore sizes as well as the bubble point. For these analyses, a Coulter Porometer Model 0204 may be used. Porometry measurements give the “mean flow pore size” of the membrane.

The mean flow pore size is based on the pressure at which air flow begins through a prewetted structure (the bubble point pressure) compared to the pressure at which the air flow rate through a prewetted structure is half the air flow rate through the same structure when dry (the mean flow pore pressure). The bubble point pressure indicates the size of the largest limiting pores, and the mean flow pore pressure indicates the mean size of the limiting pores. Accordingly, by comparing these two values, one can determine not only the average size of the limiting pores in a structure, but can also determine the uniformity of limiting pore sizes.

In addition to the bubble point method, one may also determine the permeability of a body by the well known dynamic wet pressure method. This method is described, e.g., in U.S. Pat. Nos. 5,597,491, 5,328,867, 4,889,620, 4,382,867, and reissue patent 33,177. The disclosure of each of these United States patents is hereby incorporated by reference into this specification.

It is to be understood that the aforementioned description is illustrative only and that changes can be made in the apparatus, in the ingredients and their proportions, and in the sequence of combinations and process steps, as well as in other aspects of the invention discussed herein, without departing from the scope of the invention as defined in the following claims.

I claim:

1. A ceramic diffuser assembly comprised of a diffuser fitting integrally connected to a diffuser body, wherein when said ceramic diffuser assembly is supplied with oxygen-containing gas at a pressure of from about 0.2 to about 80 pounds per square inch said gas flows through it at a rate of from about 0.5 to about 50 standard cubic feet per minute, wherein the plot of gas pressure versus flow rate is a straight line, wherein the slope of said straight line is from about 0.1 to about 4, and wherein:
(a) said diffuser body is comprised of a first ceramic layer, a second ceramic layer integrallyjoined to said first ceramic layer, and a recessed area disposed between said first ceramic layer and said second ceramic layer;
(b) said diffuser body is further comprised of a top ceramic layer, and a ceramic layer adjacent to and bonded to said top ceramic layer,
(c) said diffuser body has a length of from about 50 to about 762 millimeters and a width of from about 6 to about 90 millimeters,
(d) said recessed area has a length which is from about 50 to about 90 percent of said length of said diffuser body,
(f) said recessed area has a width which is from about 10 to about 80 percent of said width of said diffuser body, provided that said width of said recess is at least about 3 millimeters,
(g) said top layer of said diffuser body has a permeability which is from about 1 milliDarcy to about 10 Darcys and is at least about 10 percent greater than the permeability of said ceramic layer adjacent to and bonded to said top ceramic layer,
(h) said ceramic layer adjacent to and bonded to said top ceramic layer has a permeability which is from about 1 milliDarcy to about 10 Darcys,
(i) said top layer of said diffuser body has a minimum active pore size which is from about 0.2 to about 90 microns and is at least about 10 percent greater than the minimum active pore size of said ceramic layer adjacent to and bonded to said top ceramic layer,
(j) said ceramic layer adjacent to and bonded to said top ceramic layer has a minimum active pore size which is from about 0.2 to about 90 microns,
(k) each of said top layer of said diffuser body and said ceramic layer adjacent to and bonded to said top layer has an apparent porosity of from about 10 to about 90 percent, and
(l) the dynamic wet pressure of said ceramic layer adjacent to and bonded to said top ceramic layer is higher than the dynamic wet pressure of said top ceramic layer.

2. The ceramic diffuser assembly as recited in claim 1, wherein said diffuser fitting is a tubular plastic fitting.

3. The ceramic diffuser assembly as recited in claim 2, wherein said diffuser fitting consists essentially of fluorcarbon polymer.

4. The ceramic diffuser assembly as recited in claim 2, wherein said diffuser fitting consists essentially of ceramic material.

5. The ceramic diffuser assembly as recited in claim 3, wherein said fitting is comprised of a first stepped bore integrally connected to a second stepped bore.

6. The ceramic diffuser assembly as recited in claim 1, wherein a third ceramic layer is integrally joined to and contiguous with said second ceramic layer.

7. The ceramic diffuser assembly as recited in claim 6, wherein said third ceramic layer is said top ceramic layer.

8. The ceramic diffuser assembly as recited in claim 7, wherein said second ceramic layer is said ceramic layer adjacent to and bonded to said top ceramic layer.

9. The ceramic diffuser assembly as recited in claim 8, wherein the ceramic material in each of said first ceramic layer, said second ceramic layer, and said third ceramic layer is alumina.

10. The ceramic diffuser assembly as recited in claim 9, wherein said recessed area is comprised of a top surface and a bottom surface.

11. The ceramic diffuser assembly as recited in claim 10, wherein said recessed area is substantially empty.

12. The ceramic diffuser assembly as recited in claim 11, wherein said recessed area is filled with ceramic material with a grit size of from about 30 grit to 6 grit.

13. The ceramic diffuser assembly as recited in claim 11, wherein said recessed area is filled with a multiplicity of flow modifying structures extending from said bottom surface of said recessed area to said top surface of said recessed area.

14. The ceramic diffuser assembly as recited in claim 13, wherein said multiplicity of flow modifying structures extends over from about 7 to about 20 percent of the area of said bottom surface of said recessed area.

15. The ceramic diffuser assembly as recited in claim 14, wherein said top layer of said diffuser body has an apparent porosity which is at least about 10 percent greater than the apparent porosity of said ceramic layer adjacent to and bonded to said top ceramic layer.

16. The ceramic diffuser assembly as recited in claim 1, wherein said top layer of said diffuser body has an apparent porosity which is at least about 10 percent greater than the apparent porosity of said ceramic layer adjacent to and bonded to said top ceramic layer.
